(19) United States
(12) Patent Application Publication
(10) Pub. No.: US 2019/0188742 A1
(43) Pub. Date: Jun. 20, 2019

(54) FORECASTING DEMAND ACROSS GROUPS OF SKILLS

(71) Applicant: International Business Machines Corporation, Armonk, NY (US)

(72) Inventors: Shrihari VASUDEVAN, Chennai (IN); Moninder SINGH, Farmington, CT (US); Joydeep MONDAL, New Delhi (IN); Michael PERAN, Scarsdale, NY (US); Ben ZWEIG, New York, NY (US); Brian JOHNSTON, Sleepy Hollow, NY (US); Rachel M. ROSENFELD, New York, NY (US); Pankaj SRIVASTAVA, Bedford, NY (US); Owen CROPPER, Lexington, KY (US); Steven LOEHR, Hopewell Junction, NY (US)

(73) Assignee: INTERNATIONAL BUSINESS MACHINES CORPORATION, Armonk, NY (US)

(21) Appl. No.: 15/848,147

(22) Filed: Dec. 20, 2017

(51) Int. Cl. G06Q 30/02; G06Q 10/06

(52) U.S. Cl. CPC G06Q 30/0204; G06F 17/16; G06Q 10/063112

(57) ABSTRACT

Embodiments for estimating substitutability between skills by combining skill similarities from one or more data sources by a processor. An adjacency of skill similarity of one or more skills of one or more entities may be determined. The adjacency of skill similarity may be used to generate one or more skill clusters. Skill demand of the one or more skill clusters may be forecasted.

### BACKGROUND OF THE INVENTION

### Field of the Invention

The present invention relates in general to computing systems, and more particularly, to various embodiments for forecasting demand across groups of skills using a computing processor.

### Description of the Related Art

Due to the recent advancement of information technology and the growing popularity of the Internet, a vast amount of information is now available in digital form. Such availability of information has provided many opportunities. Digital and online information is an advantageous source of business intelligence that is crucial to an entities survival and adaptability in a highly competitive environment.

### SUMMARY OF THE INVENTION

Various embodiments for forecasting demand across groups of skills by a processor are provided. In one aspect, various embodiments are provided for estimation of fungibility of skills. In an additional aspect, various embodiments are provided for using skill-pairs (e.g., a pairs of skills) for encoding a sequence in a representation of people skill-transition data. The estimation of fungibility operation and using the skill-pairs operations may be used for demand forecasting, reskilling or the other applications.

In an additional aspect, various embodiments are provided for forecasting demand across groups of skills by a processor. An adjacency (e.g., fungibility) of skill similarity of one or more skills of one or more entities may be determined. The adjacency of skill similarity may be used to generate one or more skill clusters. Skill demand of the one or more skill clusters may be forecasted.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a block/flow diagram depicting forecasting demand for capacity planning according to an embodiment of the present invention;

FIG. 5 is a block diagram depicting a forecast model having increased accuracy with predictions at a skill cluster level in accordance with aspects of the present invention;

FIG. 6 is a block/flow diagram depicting estimation of skill similarity according to an embodiment of the present invention;

FIG. 7 is a block diagram depicting a forecast model prediction of required labor for future contracts in accordance with aspects of the present invention;

FIG. 8 is a block/flow diagram depicting selecting candidates for reskilling/upskilling according to an embodiment of the present invention;

FIG. 9 is a flowchart diagram depicting an additional exemplary method for estimating substitutability between skills by combining skill similarities from one or more sources by a processor; again, in which aspects of the present invention may be realized; and

FIG. 10 is a flowchart diagram depicting an additional exemplary method for creating a list for reskilling by a processor; again, in which aspects of the present invention may be realized.

### DETAILED DESCRIPTION OF THE DRAWINGS

As the amount of electronic information continues to increase, the demand for sophisticated information access systems also grows. Digital or “online” data has become increasingly accessible through real-time, global computer networks. The data may reflect many aspects of various organizations and groups or individuals, including scientific, political, governmental, educational, businesses, and so forth.

Moreover, people-driven organizations tend to rely on an employee-centric organizational structure. The representation can enable the lookup of an employee's position and association within the hierarchy. Employee skills are directly or indirectly encoded in many different information sources ranging from their curriculum vitae (“CVs”) to skill-sets and projects associated with them within the organization. As a result of this, a full understanding of the skills available in an organization is typically unavailable, even with the use of various computing systems. Direct implications of this are that the resources (people) available for a particular skill is not known and that a measure of “adjacency” between people and skills does not exist.

Agile organizations need to be responsive to changing market scenarios. Demands from products and services constantly change; this results in changing skill-set requirements. Management in an organization needs to have resource information available at multiple levels of abstraction to facilitate decision making and capacity planning, both for immediate needs and for looking into the future. For instance, it is often easier to up-skill an existing employee with closely related skills than go through the process of hiring a new employee. These goals require a notion of fungibility (substitution with minimal up-skilling) between employees and in particular, the skill sets of the employee. Similarly, a measure of fungibility between skills allows organizations to improve demand forecasts for those skills considering skill usage data from prior engagements.

Accordingly, various embodiments are provided herein for estimating fungibility (e.g., substitutability) between skills by combining skill similarities from one or more sources, again by a processor. An adjacency (e.g., fungibility) of skill similarity of one or more skills of one or more entities may be determined. The adjacency of skill similarity may be used to generate one or more skill clusters. Skill demand of the one or more skill clusters may be forecasted. In an additional aspect, the present invention enables the forecast of the skill demand in a graphical user interface (GUI) so as to visualize the forecast of the various skill sets. A short list of candidates for reskilling may be provided. A skill centric representation of an organization may be provided. A skill planning operation may also be provided along with automatically maintaining a skills taxonomy.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

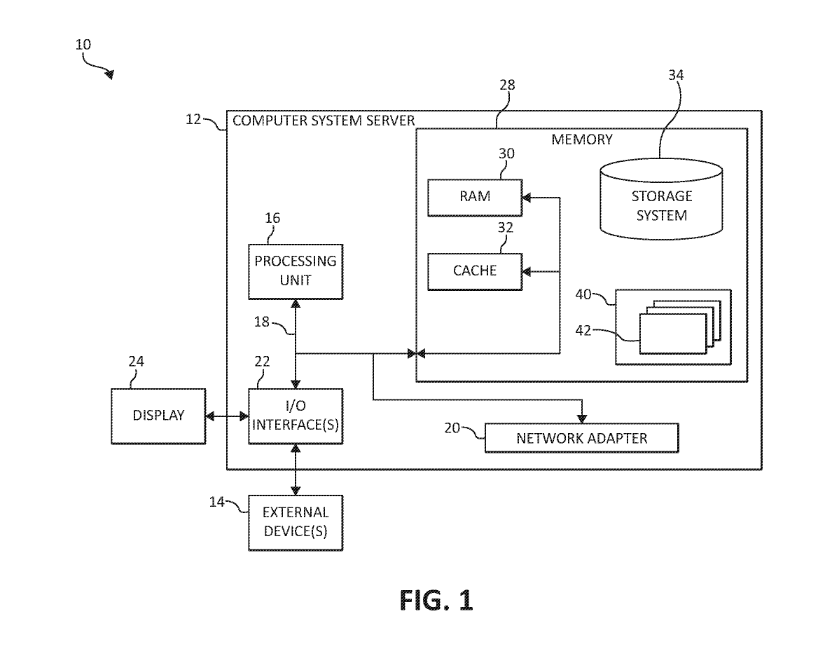

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in a moving vehicle. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

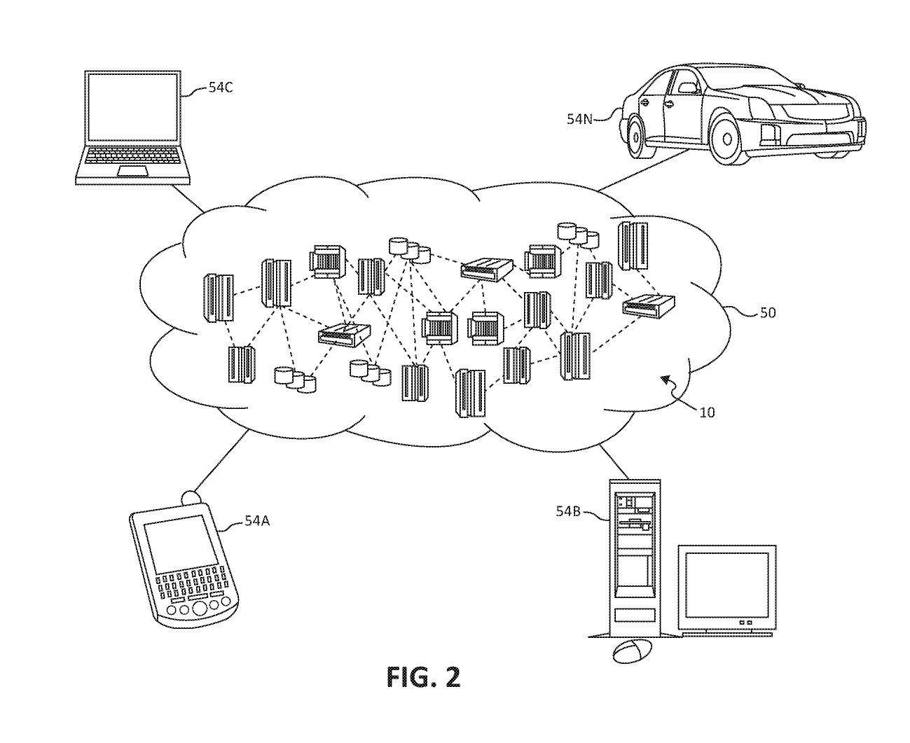

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

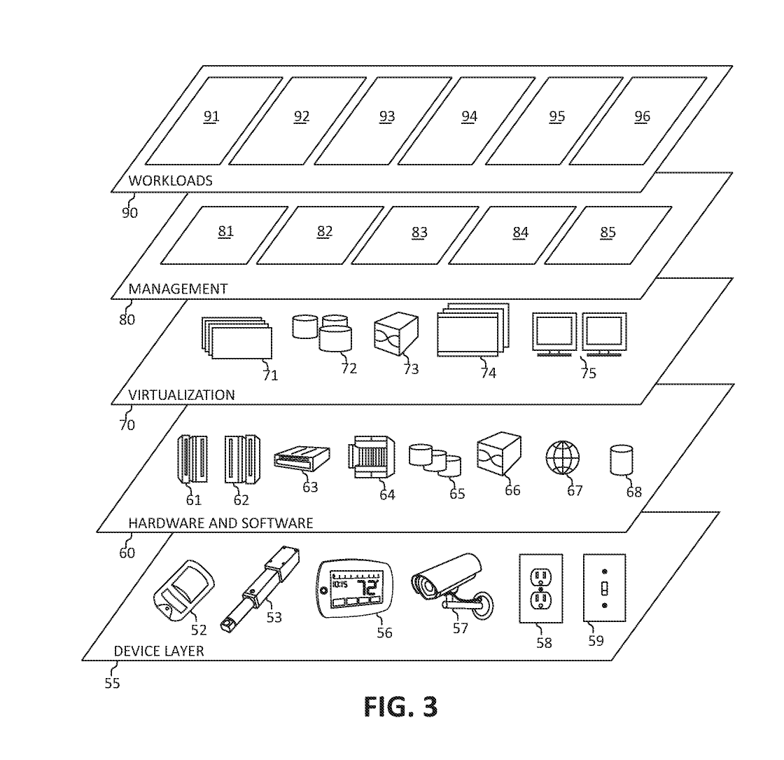

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for estimating fungibility between skills. In addition, workloads and functions 96 for estimating fungibility may include such operations as data analysis (including data collection and processing from organizational databases, online information, knowledge domains, data sources, and/or social networks/media, and other data storage systems, and predictive and data analytics functions. One of ordinary skill in the art will appreciate that the workloads and functions 96 for estimating fungibility may also work in conjunction with other portions of the various abstractions layers, such as those in hardware and software 60, virtualization 70, management 80, and other workloads 90 (such as data analytics and/or fungibility processing 94, for example) to accomplish the various purposes of the illustrated embodiments of the present invention.

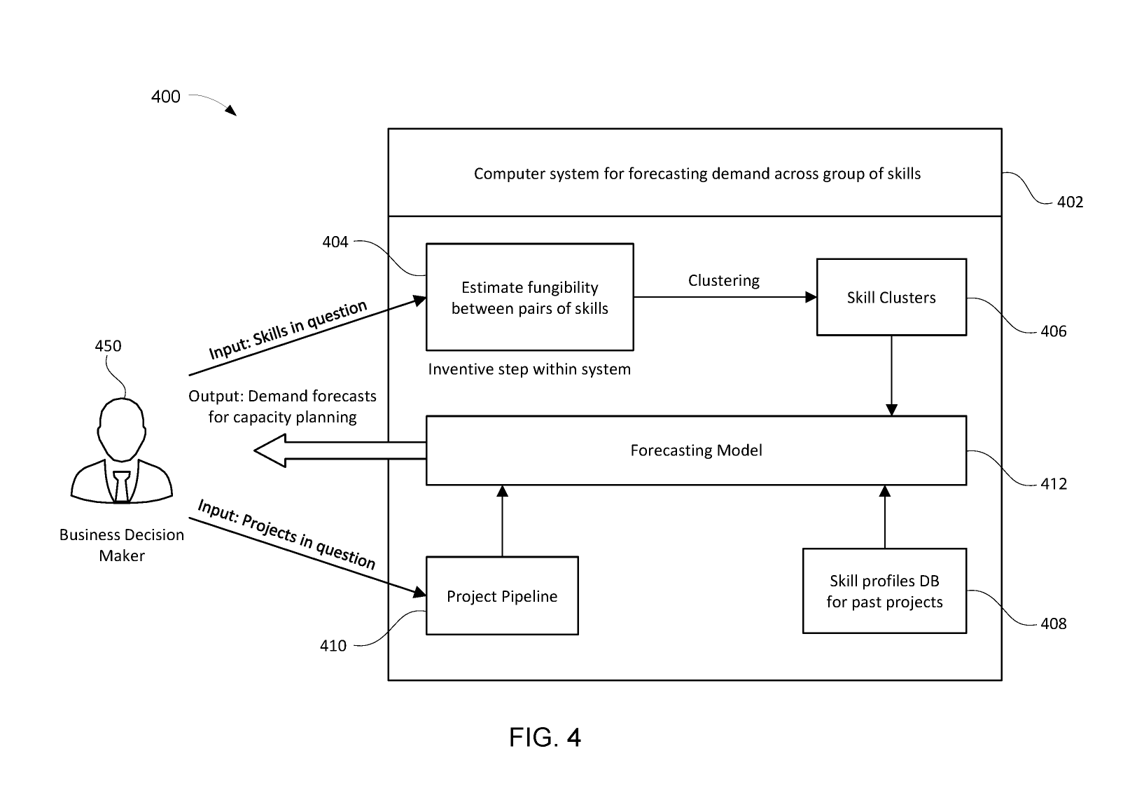

Turning now to FIG. 4, a block diagram 400 depicts forecasting demand for capacity planning. In one aspect, one or more of the components, modules, services, applications, and/or functions described in FIGS. 1-3 may be used in FIG. 4. For example, computer system/server 12 of FIG. 1, incorporating processing unit 16, may be used to perform various computational, data processing and other functionality in accordance with various aspects of the present invention.

Also, as shown, the various blocks of functionality are depicted with arrows designating the blocks' 400 relationships with each other and to show process flow. Additionally, descriptive information is also seen relating each of the functional blocks 400. As will be seen, many of the functional blocks may also be considered “modules” of functionality. With the foregoing in mind, the module blocks 400 may also be incorporated into various hardware and software components of a system for targeted learning and recruitment in accordance with the present invention. Many of the functional blocks 400 may execute as background processes on various components, either in distributed computing components, or on the user device, or elsewhere.

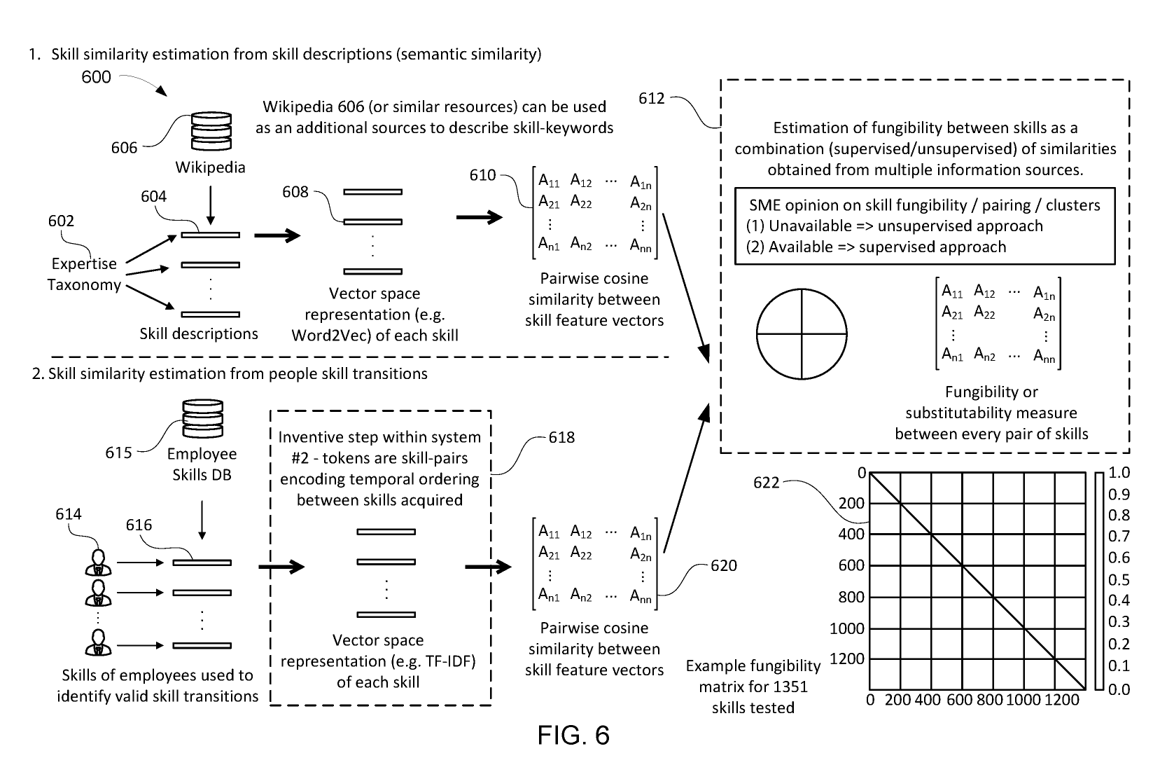

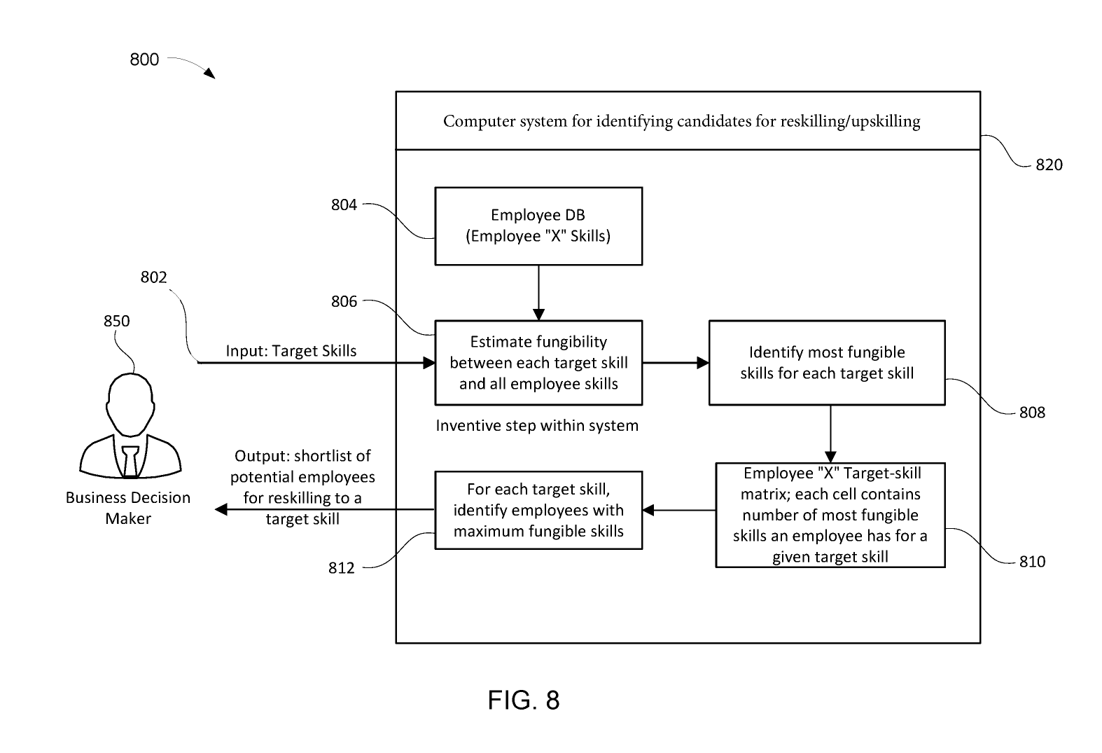

In one aspect, a computer system for forecasting demand (e.g., labor demand) across a group of skills may be in communication with one or more users such as, for example, a business decision maker 450. At block 404, the user 450 may input into the computer system 402 one or more skills (e.g., identified or target skills) and a fungibility between a pair of skills may be estimated. In one aspect, block 404 may be obtained via FIG. 6, described below. Block 404 may also be similar to block 806, described in FIG. 8. In one aspect, fungibility is a substitution of a skill with an alternative skill with a reduced amount of time for upskilling the one or more entities with the alternative skill as compared to an amount of time training a new entity with the alternative skill. A clustering operation may be performed to generate a cluster of skills, as in block 406.

Accessing a project pipeline, from block 410, relating to one or more inputs relating to one or more projects in question from user 450 and accessing a database (DB) of one or more skill profiles of one or more entities, from block 408, a forecasting model may be provided or forecasted, as in block 412. That is, the forecast model may forecast demand (e.g., labor demand) for capacity planning.

That is, fungibility may be used to generate skill clusters. It should be noted that fungibility, substitutability, and adjacency may be used herein interchangeably. Substitution of skills may be performed with minimized reskilling effort, time, and/or cost (as compared to training a new skill to a new employee). An objective measure of fungibility may be obtained by combining one or more information sources of similarity between skills. The skill clusters may then be used to forecast demand according to skill information relating to one or more previous/past projects. In this way, forecasting demand at the skill cluster level (as compared to a skill of an individual at the individual level) increases accuracy and prediction for forecasting demand. As mentioned previously, labor demands for products and/or services constantly change resulting in changing skill-set requirements. Management in an organization needs to have resource information available at multiple levels of abstraction to facilitate decision making and capacity planning, both for immediate needs and for looking into the future. For instance, it is often easier to up-skill an existing employee with closely related skills than go through the process of hiring a new employee. These goals require a notion of fungibility (substitution with minimal up-skilling) between employees and in particular, the skill sets of the employee. Similarly, a measure of fungibility between skills allows organizations to improve demand forecasts for those skills considering skill usage data from prior engagements.

Thus, forecasting labor demand at a skill-level can be very useful for capacity planning, but inaccurate because of a lack of data. The demand forecasts at a high level of abstraction (e.g., abstract skill-categories) are accurate but not useful. As such, the created skill clusters provide a tradeoff between accuracy and usability in demand forecasting. The skill adjacency/fungibility measure is the means of obtaining the skill clusters. The skill adjacency/fungibility may consider and/or access multiple information sources, which is an essential characteristic of the present invention.

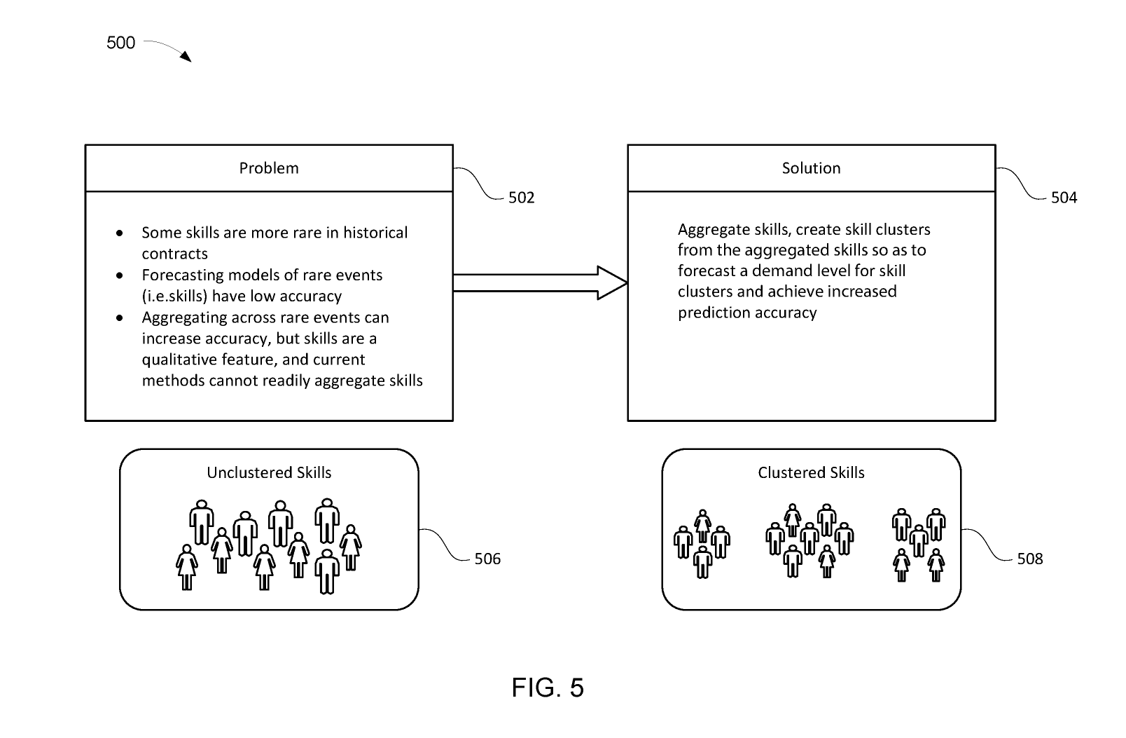

Turning now to FIG. 5 is a block diagram 500 depicts a forecast model having increased accuracy with predictions at a skill cluster level. In one aspect, one or more of the components, modules, services, applications, and/or functions described in FIGS. 1-4 may be used in FIG. 5. For example, computer system/server 12 of FIG. 1, incorporating processing unit 16, may be used to perform various computational, data processing and other functionality in accordance with various aspects of the present invention.

As illustrated, block 502 depicts a current challenge of unclustered skills 506. These challenges (e.g., problems) may include one or more skills that may be more “rare” (e.g., not as common as other skills) in previous or historical contracts of an organization. Also, forecasting models of these “rare” events (e.g., rare skills) have extremely low accuracy rates. Although aggregating across rare events may lead to increased accuracy, the current state of the art is unable to aggregate skills given that skills are a qualitative feature. However, as depicted in block 504, the present invention provides a solution that aggregates one or more skills using various aspects of the present invention to create skill clusters. The clustered skills 508 enable forecasting for the skill clusters so as to increase forecast and/or prediction accuracy.

FIG. 6 is a block/flow diagram depicting estimation of skill similarity. In one aspect, one or more of the components, modules, services, applications, and/or functions described in FIGS. 1-5 may be used in FIG. 6. For example, computer system/server 12 of FIG. 1, incorporating processing unit 16, may be used to perform various computational, data processing and other functionality in accordance with various aspects of the present invention.

As a preliminary matter, FIG. 6 depicts 1) skill similarity estimation from skill descriptions (e.g., semantic similarity), and 2) skill similarity estimation from people skill transitions. That is, FIG. 6 depicts estimation of skill similarity from one or more data sources 602, 606 (e.g., a taxonomy, Wikipedia, or other text data resource) and from people skill transitions 614, 615. For example, one data source may be from use of a taxonomy 602 of skill descriptions as illustrated in Table 1, below, and another data source may be people skill transitions data that may be stored, maintained, updated, and/or accessed via a skills database (“DB”) such as, for example, an employee skills DB 615 and the employee skills DB 615 may be used for estimating skill similarity.

In one aspect, for estimating skill similarities from one or more data sources from skill descriptions, skill similarities may be determined according to semantic similarity between one or more skills included in one or more data sources, such as, for example, a taxonomy 602 (e.g., expertise taxonomy) and/or data from a text data resource 606 (e.g., Wikipedia) or other structured text source. In one aspect, by way of example only, the taxonomy 602 may be illustrated in Table 1, by way of example only, showing the “expertise taxonomy level” in a first column and an example provided in a second column.

TABLE I
EXPERTISE TAXONOMY

| EXPERTISE TAXONOMY LEVEL | EXAMPLE |
|---|---|
| Job Category (e.g., Skill Category) | Technical Services |
| Job | System Administrator |
| Skill (e.g., a functional unit of skill | Perform system administration |
| measurement for an organization) | for a computing application |

The skill level of taxonomy may be used for decision making (e.g., the skill being a functional unit of skill measurement for an organization). A job category may have a description and one or more associated jobs. Each job may have a description and one or more associated skills. Each skill may have a description and/or one or more attributes associated with the skill. For each skill, the name of the skill, the description of the skill, any associated attributes of the skill, and/or names and descriptions of jobs and categories associated with that skill may be used. The skill may be the functional unit of skill measurement for an organization. In other words, the functional unit of skill measurement is the unit for measuring skill capacity and/or resources, and/or planning and decision making.

It should be noted that taxonomy 602 may be considered a general taxonomy, by way of example only. Thus, each organization or individual enterprises may have various generalizations or specializations of taxonomy 602. Thus, each taxonomy may be enhanced, adapted, modified, and/or created according to the needs of the user/organization. As such, as described herein, various embodiments of the present invention may also be performed whether or not a taxonomy is available. For example, for some organizations such as, for example, a company with limited resources (e.g., a company without a human resource department), the present invention may rely entirely on a data source such as, for example, public information sources of skill descriptions (e.g., an online internet webpage such as “Wikipedia”). For other organizations, such as, for example, a large corporation, the present invention may use a taxonomy (e.g., an in-house taxonomy), if available. In short, the present invention may use, access, and/or rely on various resources so as to retrieve, learn, and/or analyze descriptions from one or more source(s) of the functional unit of skill measurement for that organization.

Accordingly, the taxonomy 602 may be used in conjunction with the text data resource 606 for providing skill descriptions to each skill, as in block 604. That is, each skill may have associated key words and descriptions. A similarity measure between the descriptions associated with two skills may be provided for providing a measure of semantic similarity between the skills. A vector space representation (e.g., “Word2Vec”) may be provided for each skill, as in block 608.

In one aspect, a neural network operation may be used to learn vector representations of words to capture semantic context (co-occurrence of words) for the skill descriptions. For example, the present invention may provide two operations for learning word vectors: 1) continuous bag of words (CBOW), and 2) skip-gram (SG). The difference between the CBOW and SG is in the input-output combinations and their physical interpretations. Both approaches operate on strings of words, the input text being a collection of strings of words. The CBOW approach learns to predict a word given its context (co-occurring) words. The SG approach, on the other hand, learns to predict context words for a given word. After the learning stage, each word has a vector representation. The word-vector representations of the skills may be learned using the vector space representation SG operation that learns words that co-occur with the skill word.

Semantic similarity between two skills may be determined/computed as the cosine similarity between the representations of every pair of skills (e.g., pairwise cosine similarity); the result is a similarity matrix, as in block 610. That is, similarity between words can be computed by a cosine similarity between the corresponding feature vectors of the skills so as to capture syntactic and semantic regularities.

In an additional aspect, estimating skill similarities may be determined from people-skill data, as in block 616. That is, one or more persons 614 may have one or more skills identified, stored, and/or maintained in a person (e.g., employee) skills database (DB) 615. In other words, the skills of each person 614 (e.g., employee) may be used to determine and/or compute skill similarities based on the notion that if a person from the persons 614 has two skills, then the person may be trained from one skill to another skill. As such, each skill may be identified and analyzed. A profile may be determined/computed (based on the identification and the analyzing) for that skill consisting of the union of all skills possessed by each of the persons 614 with a selected skill. Then, similarity between the profiles of two skills provides a measure of the adjacency between the pair of skills.

In one aspect, in order to determine and/or compute the people-skill similarity, the present invention may use term-frequency inverse-document-frequency (TF-IDF) representation. The term-frequency (TF) may represent the frequency of the occurrence of a token (e.g., term or word) within a document, and measures or determines how common the token (e.g., term or word) is in the document. The inverse-document-frequency (IDF) may measure how often (e.g., a number of times) that token occurs in a corpus of documents, and is a measure of its discriminating power between documents. For example, given a corpus of documents, each of which being a collection of words, the IDF may measure the ability of each word to distinguish, discriminate, and/or identify a particular document from the corpus. The product of the two terms (TF-IDF), thus, provides a measure of the importance of a token to the document, in a corpus of documents. High TF-IDF suggests that a term occurs frequently (e.g., a defined number of times) in a document but in few other documents and may be used to distinguish a document from other documents.

Every document may be represented as a feature vector comprising of TF-IDF measures of tokens (e.g., words or terms) within that document. Similarity between documents may be computed as the cosine similarity between their respective TF-IDF feature vector representations. Thus, estimating skill-similarity using people skill data may be performed by providing a vector space representation (e.g., TF-IDF) of each skill, as in block 618. The tokens may be pairs of skills (“skill-pairs”) encoding temporal ordering between acquired skills. Skill similarity between two skills may be determined/computed as the cosine similarity between the representations of every pair of skills (e.g., pairwise cosine similarity); the result is a similarity matrix, as in block 620.

For example, for every skill “S,” a “document” may be constructed that may include every skill (“token”) that a person (e.g., one or more persons 614) with skill “S” has transitioned from. Then, the term-frequency (TF) for skill “T” in that document represents a number of people, from the one or more persons 614, with skill “S” who also have skill “T.” Similarly, the IDF for skill “T” measures how common the skill “T” is across people with all skills. Thus, every skill “S” may be represented by a TF-IDF feature vector representation, and skill similarity may be determined and/or computed as the cosine similarity between the feature vectors. In this way, the skill similarity encodes the historical people based evidence in the organization. For a given set of skills, a similarity matrix is thus obtained.

Accordingly, one or more similarity matrices from 610 and 620 may be combined (e.g., similarity matrix integration) to produce a resultant matrix so as to estimate fungibility between skills as a combination (e.g., supervised/unsupervised integration) of similarities obtained from the multiple information sources (e.g., similarity from skill descriptions from data sources and/or similarity from people skill data), as in block 612. Also, block 612 indicates that if a subject matter expert (“SME”) description or opinion on relating to skill fungibility, pairing, and/or clusters is 1) unavailable to then perform an unsupervised integration (e.g., principal component analysis “PCA” as described below), and 2) available to perform a supervised integration (e.g., a weighted linear combination “LINSUM” as described below).

### Estimating Fungibility Between Skills

In one aspect, the fungibility (or substitutability) between skills may be estimated as a composite similarity measure obtained by combining skill similarities obtained from multiple information sources, as described above in block 612. That is, the two sources of skills information (e.g., skill descriptions and people skill-transitions) may be used. It should be noted that given the skill similarity measures from various data sources, the composite similarity measure may be herein referred to as the “fungibility” and may be a consolidated, integrated, and/or fused similarity measure between those skills. Pairwise skill-similarity matrices (generated at blocks 610, 620) obtained from the two sources of skills information may be integrated into a single measure of fungibility or substitutability between skills, as in block 612, which may also be a pairwise matrix between skills. One or more additional options may include additional data sources/metrics such as, for example, a number-of-years, a type of experience (on-site, off-site), or other defined sources/metrics relating to skills, each of which may produce additional similarity matrices between skills. In this way, the additional similarity matrices between skills may be selectively applied and used according to one or more defined constraints within a specific application problem such as, for example, the type of job, contract, or work that may be required by a person associated with an organization (e.g., an employee). The resulting fungibility matrix can in turn provide the basis for any subsequent clustering of skills to develop skill-centric representations of an organization and for applications such as, for example, short term capacity planning, strategic planning, shortlisting of candidates for reskilling and other skill based analyses. Combining similarity matrices can be done in a supervised or unsupervised manner depending on the data that exists, again, as illustrated in block 612.

### Unsupervised Integration Using PCA

In one aspect, an unsupervised operation to similarity matrix integration may be useful when no prior subject matter expert (SME) opinion or information on fungible skills exists. In such cases, similarity matrix integration may be used to maximize information captured in the resulting matrix of the input similarity matrices such as, for example, by using principal component analysis (PCA). PCA is a linear orthogonal projection of data. That is, the PCA is a statistical procedure that uses an orthogonal transformation to convert a set of observations of possibly correlated variables into a set of values of linearly uncorrelated variables called principal components. The linear orthogonal projection of data produces components that maximize a data-variance that the components account for. Thus, the projection of the data along the first component captures most of the variance in the data. The projection along the second component is the next most informative, in this respect, and so on.

Integration of similarity matrices may be performed by projecting the data from the two matrices, taken together, along the first principal component that will maximally capture the variance in the input similarity matrices. The PCA operation for integration of similarity matrices may be unsupervised in that it does not require SME input and relies only on the principle of information (variance) maximization. The PCA operation approach is approximate in that information captured by projections along the second and subsequent components may be lost and the quality of integration is dependent on the amount of variance the first component is able to capture.

### Unsupervised Integration Using People Data Support (PDS)

In an additional aspect, an unsupervised operation for similarity matrix integration may be performed using people data support (PDS). The unsupervised operation for similarity matrix integration may use people (skill-transition) but also use skill description data as an alternative, when people-data information about skill pairs is unavailable or unreliable. Similarity matrix integration may be performed as a linear weighted sum of the individual matrices (people and description data similarities). The weights (pwt) for the skill similarity matrix obtained from people skill data are computed as follows; the weights (dwt) for the similarity matrix obtained from description data are obtained as dwt=[1]−pwt. Given the skill similarity matrix from people data (Sₚ) and the skill similarity matrix from description data (Sₑ), the resulting fungibility matrix is given by the Equation:

S=(pwt·Sₚ)+(dwt·Sₑ) (1)

It should be noted that people skill data may be scarce for many skill pairs particularly in light that may organizations fail to update skills information. Accordingly, the variables “nᵢ” may represent a number of people with skill “i,” and “nⱼ” may represent a number of people with skill “j” and n_{i,j} may represent a number of people who have both skills i and j. A maximum number of people that can have both skills is min (nᵢ, nⱼ). Thus, a measure of people data support for a given pair of skills is given by the Equation:

pwtᵢⱼ=nᵢⱼ/min(nᵢ,nⱼ) (2)

In one aspect, a measure of people data support may be trusted such as, for example, when a selected amount of information on individual skills is available. Thus, the denominator (min (nᵢ, nⱼ)) in formula 2 may be lower bounded by some desired threshold. That is, if min(nᵢ, nⱼ) is less than the lower bound chosen (e.g., the median), then the lower bound (which is the larger of the two) is chosen as the denominator and pwt may be significantly penalized driving the pwt towards zero and suggesting that the confidence in people skill-transition data for that skill pair is low. In this case, the fungibility score estimate relies more on the description similarity score. For example, based on an empirical plot of a number of employees with each skill, percentiles (including median) of numbers may be selected as the lower bound. Thus, the people data support for a pair of skills (i and j) is given by the Equation:

pwtᵢⱼ=nᵢⱼ/max(percentile(nₖ),min(nᵢ,nⱼ)) (3)

where k may be a range(s) over a set of all person (e.g., employee) counts over individual skills. This measure effectively penalizes PDS values where the maximum possible support is below a confidence threshold. Said differently, all of the skills may be identified or determined and then a number of employees with each of the identified skills (denoted as n) may be counted. k may analyze or process (e.g., run over) a list of counts (that may be sorted) and hence n₁ is equal to a number of employees with first skill, n₂ is equal to a number of employees with second skill, and so on. Thus, the first few skills have zero or few employee counts; the last skills may have many employee counts and percentiles of this range are chosen as lower bounds to identify the strength of the supporting data for a given pair of skills.

A variation of the above penalty-based PDS computation is one of a switching model between people skill-transition similarities and skill-description similarities based on whether a maximum possible support exceeds a threshold. In this case, a measure of people data support for a given pair of skills is given by Equation 2 such as, for example, if min(nᵢ, nⱼ) is less than (“>”) the percentile (nₖ) and zero otherwise, which may result in the use of description based similarities. As before, the threshold may be empirically selected as percentiles of numbers of people with each skill in consideration.

### Supervised Integration Using Some Fungible Skills

When SME information about fungible skills (e.g., pairs or clusters of skills) is available, a supervised integration operation may be used to combine similarity matrices. The supervised integration for similarity matrix integration may produce a resultant matrix that maximizes a likelihood of occurrence of one or more exemplars provided by the SME. For example, the SME exemplar may be the following skills that are fungible: 1) System Administrator—computer application “A,” 2) System Administrator—computer application “B,” 3) System Administrator—computer application “C,” and/or 4) System Administrator—computer application “D.” In one aspect, a weighted linear combination (LINSUM) of (normalized) similarity matrices that maximizes a clustering outcome F-measure score (or similar metric) may be identified for a given set of exemplars. The search for weights for the LINSUM of (normalized) similarity matrices may be performed using a variety of optimization operations (e.g., an “off-the-shelf” optimization tool). Bounds on weights and constraints (e.g., sum of weights=1) may be defined or selected so as to increase the efficiency of a search process. It should be noted that as used herein, “precision” may refer to a fraction of the clustering outcomes that are correct, “recall” may refer to a fraction of the SME exemplar skill-pairs produced in the clustering outcome, the “F-measure” may refer to a harmonic mean of precision and recall, and/or the “harmonic mean” may refer to a reciprocal of average of reciprocals.

In one aspect, supervised integration using some fungible skills may be performed according to the following steps. Step 1) An SME may provide valid skill clusters representing fungible sets of skills. Step 2) Normalized similarity matrices (range=[0, 1]) may be calculated. Sub-matrices of the similarity matrices containing only skills referred to in the SME exemplars may be extracted. Step 3 operates on only the sub-matrices to estimate weights. Step 3) For every set of weights in the search space of weights, the following may be performed. A) A linear weighted sum of similarity sub-matrices may be computed to obtain a single fungibility matrix between skills. B) A clustering operation may be performed to obtain skill clusters (e.g., partitioning around medoids (PAM) or hierarchical clustering). A number of skill clusters may be set based on the number of SME provided exemplar skill clusters and hierarchical clustering can select the clustering level. C) Skill-pairings may be generated from the clusters (e.g., cluster with (1,2) gives (1,1), (1,2), (2,1) and (2,2)). D) A precision operation (e.g., a fraction of the clustering outcomes that are correct), a recall operation (e.g., a fraction of the SME exemplar pairs produced in the clustering outcome), and F-measure operation (e.g., a harmonic mean of the precision operation and recall operation) of clustering outcome may be computed with respect to given SME exemplars. E) A record of the F-measure may be maintained for the set of weights used; in an optimization tool, the cost function would be the F-measure with the objective being its maximization. Said differently, the present invention may evaluate a clustering outcome against that provided by an SME. The mechanisms of the illustrated embodiments may evaluate the clustering outcome by taking the clusters obtained and computing skill-pairs, taking SME clusters and computing their skill-pairs, then computing precision, recall and F-measure between these two sets of skill-pairs. The precision measures how many skill-pairs that may be generated are correct (against the SME pairs), the recall measures how many of the SME skill-pairs are able to be retrieved, and the F-measure consolidates these measures into a single score.

In step 4) One or more weights may be selected that maximize the F-measure of the clustering outcome. In the event that multiple solutions are obtained, a first solution may be selected. Also, other methods can also be used (e.g., maximize sum of precision and recall and use most similar weights to balance information from different sources). For example, assume there is a tie between two weight combinations that both produce the same F-measure. Because it is essential, you need a way in order to select one of the solutions. As such, other heuristics may be incorporated to break the tie such as, for example, most similar weights or weights that also maximize the sum of precision and recall or some such approach.

In step 5) Given the weights that may be obtained, a resulting fungibility (or substitutability) matrix may be the linear weighted sum of the individual similarity matrices (that have been combined together).

By way of example only, block 622 depicts an exemplary fungibility matrix for a selected number of skills tested (e.g., 1351 skills tested). Assume, for example, the set of 1351 skills is from a large information technology (“IT”) organization. Each skill may have associated metadata, capabilities, and descriptions associated therewith. The skills may be subject to pre-processing to handle word-variations (short forms), typos, singular/plural word forms, uninformative words, symbols and punctuation marks. Pre-processed words may be concatenated into lists of words with the skill word as an additional identifier/tag word for each such list. The pre-processed data may be used as input to learn vector space representation model (e.g., “Word2Vec”) or “feature vector” for a skill tag word. The vector space representation (e.g., “Word2Vec”) may learn to predict co-occurring words to the skill word in question. Given feature vectors for each skill, pairwise similarities between them can be computed using the cosine similarity between the corresponding feature vectors. The result is a similarity matrix obtained from skill descriptions.

For example, employee records of over 400 thousand employees were mined, in this example, to extract the current skills and all skills associated with each employee until a current time. A percentile plot of employee counts per skill may be generated. A TF-IDF feature vector representation for each skill may be learned in terms of all skills in question. The TF and IDF values for each token may be decided by the employee skill records. As before, given feature vectors for each skill, pairwise similarities between the pair of skills may be determined and/or computed using the cosine similarity between corresponding feature vectors. The result is a similarity matrix obtained from employee skill records. Thus, block 622 depicts the fungibility matrix integrating both people-skill and description-skill similarities such as, for example, by using the unsupervised PCA operation.

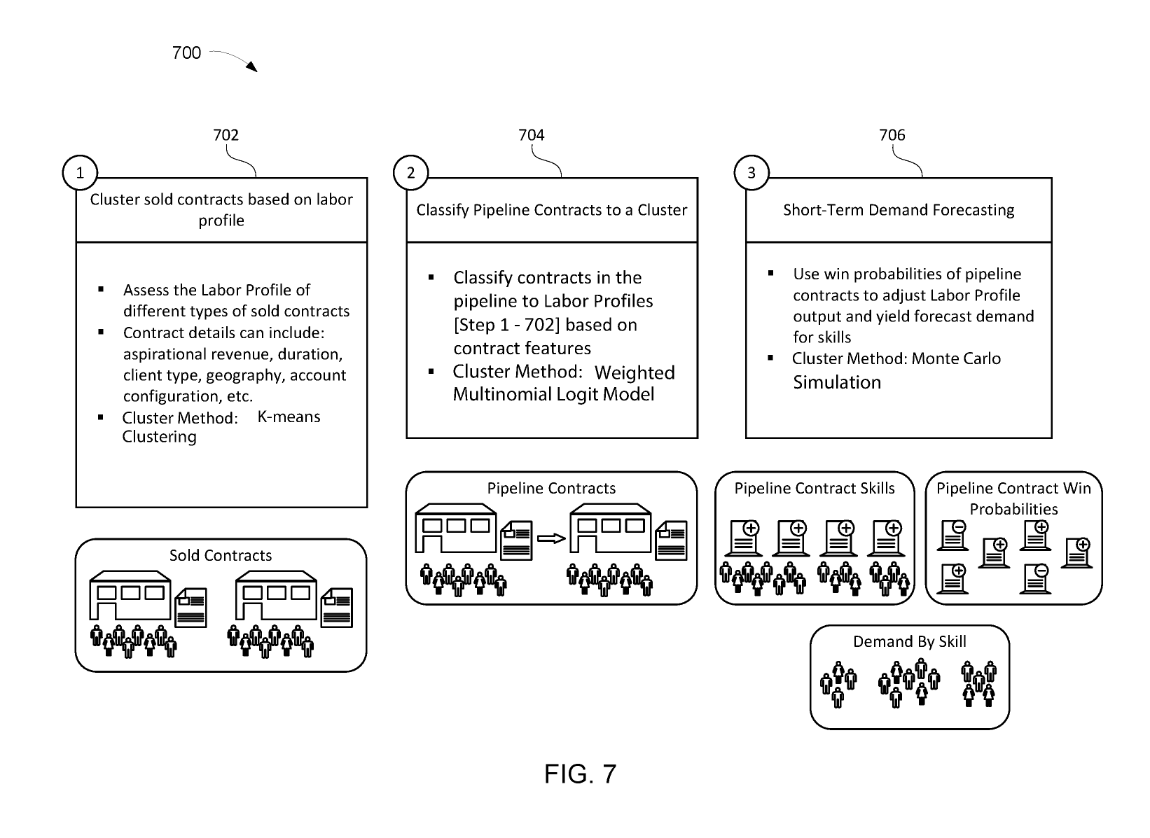

Turning now to FIG. 7, block diagram 700 depicts a forecast model prediction of required labor for future contracts. In one aspect, one or more of the components, modules, services, applications, and/or functions described in FIGS. 1-4 may be used in FIG. 5. For example, computer system/server 12 of FIG. 1, incorporating processing unit 16, may be used to perform various computational, data processing and other functionality in accordance with various aspects of the present invention.

Starting in block 702, a one or more previously sold contracts may be clustered based on a labor profile. A labor profile of different types of previously sold contracts may be assessed for using the forecast model prediction model. The details of previously sold contracts may include, for example, revenue, contract durations, geography, account configuration information, etc. The clustering operation for clustering the one or more previously sold contracts may be performed using a K-means clustering operation, which may be distinct from the skill clustering operations as described above. In block 704, those of the one or more previously sold contracts in a pipeline for clustering may be classified based on contract features. A weighted multinomial-logit model, for example, may be used for the classifying. In block 706, a forecast model prediction model may forecast a labor demand (e.g., short-term demand). The forecast model prediction model may use a probability or percentage of the wins of the one or more previously sold contracts in the pipeline to adjust the labor profile output and may also provide or yield a forecast demand for the skills required. In one aspect, a Monte Carlo Simulation operation may be used for the short-term demand forecast.

In one aspect, the functionality 700 for skill demand forecasting may include fungibility estimation used to cluster skills into skill-clusters. A dataset of skill-cluster may be created. That is, dataset of skill-cluster shares of historical opportunities may be created (e.g., shares of columns and/or rows of historical opportunities of a taxonomy). In one aspect, one or more processing or “engagement operations” can use one or more skill-clusters (e.g., skill-cluster shares); each of which may have one or more skills. Thus, if the skill clusters are clustered as cluster 1 (“C1”), cluster 2 (“C2”), cluster (“C3”), cluster (“C4”), and so forth, engagement operation “A” may take C1, C4, and engagement operation “B” may use C2 and C3.

In one aspect, a K-means clustering operation was performed on the skill-cluster shares. The number of skill clusters may be empirically chosen such as, for example, a selected number (e.g., 17). These skill clusters may be called labor profiles. A weighted multinomial-logit model may be used and trained using historical opportunity features (e.g., revenue, duration, etc.) to predict the labor profiles. The weight may be based on claim recency (e.g., a time decay function) and a size (e.g., a total number of claim hours). An opportunity with many claims that recently occurred is given the most weight. The reason for this is because recent, large claims are more likely to decide the labor profiles needed for future opportunities. The trained weighted multinomial-logit model may be applied on pipeline opportunities (i.e., represented by features such as, for example, revenue, duration of job, etc.) to predict the probability of the opportunity using the labor profiles (e.g., the 17). Weights are not used for this step. A dot product of the predicted probabilities with the weighted average shares of each labor profile may provide an estimate of predicted share of skill-clusters per pipeline opportunity. Using a separate linear model between expected revenue and hours, a total number of hours for each pipeline opportunity may be obtained. When multiplied by the predicted skill-cluster shares, predicted hours per skill cluster per potential opportunity may be obtained. A machine learning operation and/or simulation operation such as, for example, a Monte Carlo Simulation operation may be used for the short-term demand forecast. The Monte Carlo Simulation operation may be used for the short-term demand forecast to generate win probabilities. For example, for 100 thousand simulations, a 1 or 0 may be assigned to each pipeline opportunity based on the win probability of each simulation. The product of these simulations, along with the expected hours and a summation of the hours for each skill cluster may yield 100 thousand possible expected hours for each skill cluster. This distribution may be used to derive a demand forecast with confidence intervals for each skill cluster, which may be used as a final output.

FIG. 8 is a block/flow diagram depicting selecting candidates for reskilling/upskilling. In one aspect, one or more of the components, modules, services, applications, and/or functions described in FIGS. 1-7 may be used in FIG. 8. For example, computer system/server 12 of FIG. 1, incorporating processing unit 16, may be used to perform various computational, data processing and other functionality in accordance with various aspects of the present invention.

Also, as shown, the various blocks of functionality are depicted with arrows designating the blocks' 800 relationships with each other and to show process flow. Additionally, descriptive information is also seen relating each of the functional blocks (or functional steps) 800. As will be seen, many of the functional blocks may also be considered “modules” of functionality. With the foregoing in mind, the module blocks/steps 800 may also be incorporated into various hardware and software components of a system for targeted learning and recruitment in accordance with the present invention. Many of the functional blocks 800 may execute as background processes on various components, either in distributed computing components, or on the user device, or elsewhere.

In one aspect, a computer system 820 for selecting candidates for reskilling/upskilling may be in communication with one or more users such as, for example, a business decision maker 850. At step (block) 802, the user 850 may input into the computer system 820 one or more target skills. A database (e.g., an employee database) may send for acquiring skills associated with each person (e.g., employee), as in block 804. A fungibility between each target skill and all persons' (e.g., employee) skills may be estimated, as in block 806 (similar to block 404 in FIG. 4).

At block 808, one or more most fungible skills for each target skill may be identified (as compared to other fungible skills that are less fungible as they relate to the target skill). At block 810, a matrix of candidates (e.g., employee candidates) identified for the target skill (e.g., target skill “x”) may be generated. Each cell of the matrix may contain a number of the most fungible skills that the candidate (e.g., employee candidate) has for the target skill as compared to other skills less fungible for the target skill. For each target skill, one or more candidates (e.g., employee candidates) with a maximum number of fungible skills (as compared to other candidates having less fungible skills) may be identified, as in block 812. That is, the matrix may be used to identify one or more candidates (e.g., employee candidates) for reskilling with the target skills. A shortlist of potential employees for reskilling to the target skill may be provided (e.g., via an interactive graphical user interface “GUI” on a computing device) to the user 850. That is, the user 850 may be presented with the shortlist via the GUI to enable the user 850 to further interact with the output (e.g., the shortlist) to reason on the shortlist.

As described herein, a knowledge domain, thesaurus or ontology may be used with an employee database (DB) for the identification of one or more skills of the employee. That is, the ontology may also be used as input information for defining, describing, updating, enhancing, and/or explaining one or more skills of a person.

In one aspect, the term “domain” is a term intended to have its ordinary meaning. In addition, the term “domain” can include an area of expertise for a system or a collection of material, information, content and/or other resources related to a particular entity or subject or subjects relating to the entities. For example, a domain can refer to governmental, financial, healthcare, advertising, commerce, scientific, industrial, educational, medical and/or biomedical-specific information. A domain can refer to information related to any particular entity and associated data that may define, describe, and/or provide a variety of other data associated with one or more entities such as, for example, skills associated with a particular form of labor, work, or job task. The domain can also refer to subject matter or a combination of selected subjects.

The term ontology is also a term intended to have its ordinary meaning. In one aspect, the term ontology in its broadest sense may include anything that can be modeled as ontology, including but not limited to, taxonomies, thesauri, vocabularies, and the like. For example, an ontology may include information or content relevant to a domain of interest or content of a particular class or concept. Content can be any searchable information, for example, information distributed over a computer-accessible network, such as the Internet. A concept can generally be classified into any of a number of concepts which may also include one or more sub-concepts. Examples of concepts may include, but are not limited to, labor markets, skill information, job information, scientific information, healthcare information, medical information, biomedical information, business information, educational information, commerce information, financial information, pricing information, information about individual people, cultures, groups, sociological groups, market interest groups, institutions, universities, governments, teams, or any other information group. The ontology can be continuously updated with the information synchronized with the sources, adding information from the sources to the ontology as models, attributes of models, or associations between models within the ontology.

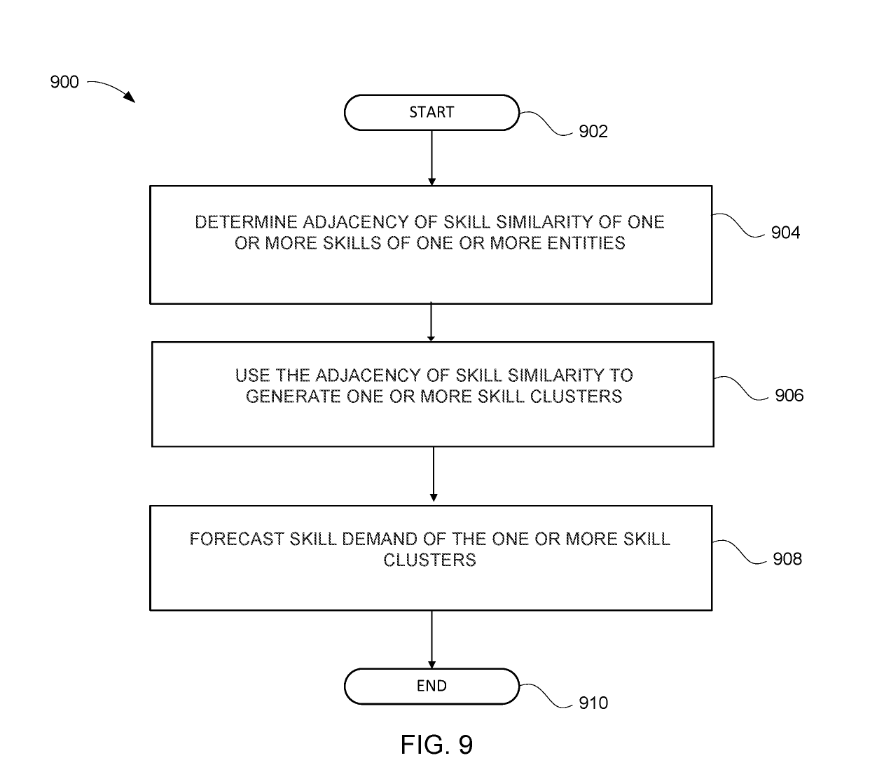

Turning now to FIG. 9, a method 900 for estimating substitutability between skills by combining skill similarities from one or more sources by a processor is depicted, in which various aspects of the illustrated embodiments may be implemented. That is, FIG. 9 is a flowchart of an additional example method 900 for estimating substitutability between skills by combining skill similarities from one or more sources in a computing environment according to an example of the present invention. The functionality 900 may be implemented as a method executed as instructions on a machine, where the instructions are included on at least one computer readable medium or one non-transitory machine-readable storage medium. The functionality 900 may start in block 902. An adjacency of skill similarity of one or more skills of one or more entities may be determined, as in block 904. The adjacency of skill similarity to generate one or more skill clusters, as in block 906. Skill demand of the one or more skill clusters may be forecasted, as in block 908. The functionality 900 may end in block 910.

In one aspect, the functionality 900 may include each of the following as a separated operation. For example, the adjacency of skill similarity of one or more skills of one or more entities may first be determined. Second, a clustering operation may be performed to generate the one or more skill clusters. Third, a skill demand of the one or more skill clusters may be forecasted.

In one aspect, in conjunction with and/or as part of at least one block of FIG. 9, the operation of 900 may include one or more of each of the following. The operation of 900 may determine the adjacency of skill similarity according to semantic similarity between one or more skills included in one or more data sources. A fungibility (or substitution) between the one or more skills may be estimated. That is, the fungibility may be a substitution of a skill with an alternative skill with a reduced amount of time for upskilling the one or more entities with the alternative skill as compared to an amount of time training a new entity with the alternative skill.

The operation of 900 may estimate fungibility between one or more skills as a combination of similarities from one or more data sources using an unsupervised and/or supervised operation according to one or more data sources resulting in a measure of fungibility. The fungibility may be used to generate the one or more skill clusters; and/or forecast the skill demand at a level of the one or more skill clusters. The operation of 900 may generate one or more similarity matrices; and/or combine the one or more similarity matrices into a single measure of fungibility. The operation of 900 may identify those of the one or more skills being most fungible for a target skill; and/or filter the one or more entities for upskilling the target skill. The one or more entities having a greater amount of fungible skills as compared to alternative entities may be identified.

The operation of 900 may use one or more skill-pairs for encoding a skill acquisition sequence from people skill-transition data for determining the skill similarity. In one aspect, a TF-IDF may be used for representing the people skill-transition data as vectors. The operation of 900 may predict the skill demand according to the fungibility of one or more skill clusters to the target skill, historical engagements and pipeline engagements for the target skill, a factor of uncertainty for one or more pipeline engagements such as, for example, using a Monte Carlo simulation, or a combination thereof. The Monte Carlo simulation is one way of incorporating uncertainty in an estimate. However, one or more alternative operations to factoring uncertainty may be used such as, for example, a machine learning mode, prior knowledge and consequent manual setting of uncertainty for the forecasts obtained, and/or a combination of both prior knowledge and the Monte Carlo operation.

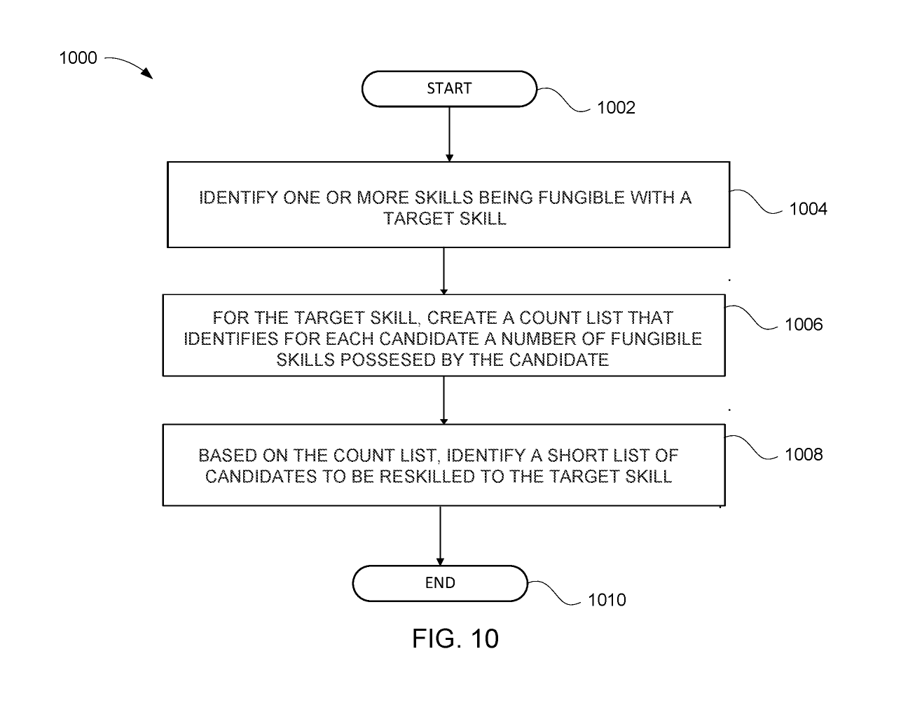

Turning now to FIG. 10, a method 1000 for creating a list for reskilling by a processor is depicted, in which various aspects of the illustrated embodiments may be implemented. That is, FIG. 10 is a flowchart of an additional example method 1000 for estimating substitutability between skills by combining skill similarities from one or more sources in a computing environment according to an example of the present invention. The functionality 1000 may be implemented as a method executed as instructions on a machine, where the instructions are included on at least one computer readable medium or one non-transitory machine-readable storage medium. The functionality 1000 may start in block 1002.

One or more skills being most fungible (as compared with other skills) with a target skill may be identified, as in block 1004. For the target skill, a count list may be created that identifies for each candidate a number of fungible skills possessed by the candidate, as in block 1006. Based on the count list, a short list of candidates to be reskilled to the target skill may be identified, as in block 1008. The functionality 1000 may end in block 1010.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for forecasting demand across groups of skills by a processor, comprising:
determining adjacency of skill similarity of one or more skills of one or more entities;
using the adjacency of skill similarity to generate one or more skill clusters; and
forecasting skill demand of the one or more skill clusters.

2. The method of claim 1, further including determining the adjacency of skill similarity according to semantic similarity between a description of one or more skills included in one or more data sources, people skill-transition data, or a combination thereof.

3. The method of claim 1, wherein determining the adjacency further includes estimating fungibility between the one or more skills, wherein fungibility is a substitution of a skill with an alternative skill with a reduced amount of time for upskilling the one or more entities with the alternative skill as compared to an amount of time training a new entity with the alternative skill.

4. The method of claim 3, further including:
using the fungibility to generate the one or more skill clusters; and
forecasting the skill demand at a level of the one or more skill clusters.

5. The method of claim 1, further including:
generating one or more similarity matrices; or
combining the one or more similarity matrices into a single measure of fungibility.

6. The method of claim 1, further including:
identifying those of the one or more skills being most fungible for a target skill; and
filtering the one or more entities for upskilling to the target skill according to the identified one or more skills.

7. The method of claim 1, further including identifying the one or more entities having a greater amount of fungible skills as compared to alternative entities.

8. The method of claim 1, further including using one or more skill-pairs for encoding a skill acquisition sequence from people skill-transition data for determining the skill similarity.

9. The method of claim 1, further including predicting the skill demand according to the fungibility of one or more skill clusters to the target skill, historical engagements and pipeline engagements for the target skill, a factor of uncertainty for one or more pipeline engagements, or a combination thereof.

10. A system for forecasting demand across groups of skills, comprising:
one or more computers with executable instructions that when executed cause the system to:
determine adjacency of skill similarity of one or more skills of one or more entities;
use the adjacency of skill similarity to generate one or more skill clusters; and
forecast skill demand of the one or more skill clusters.

11. The system of claim 10, wherein the executable instructions determine the adjacency of skill similarity according to semantic similarity according to a description between one or more skills included in one or more data sources, people skill-transition data, or a combination thereof.

12. The system of claim 10, wherein the executable instructions estimate fungibility between the one or more skills, wherein fungibility is a substitution of a skill with an alternative skill with a reduced amount of time for upskilling the one or more entities with the alternative skill as compared to an amount of time training a new entity with the alternative skill.

13. The system of claim 12, wherein the executable instructions:
use the fungibility to generate the one or more skill clusters; and
forecast the skill demand at a level of the one or more skill clusters.

14. The system of claim 10, wherein the executable instructions:
generate one or more similarity matrices; or
combine the one or more similarity matrices into a single measure of fungibility.

15. The system of claim 10, wherein the executable instructions:
identify those of the one or more skills being most fungible for a target skill; and
filter the one or more entities for upskilling to the target skill according to the identified one or more skills.

16. The system of claim 10, wherein the executable instructions identify the one or more entities having a greater amount of fungible skills as compared to alternative entities.

17. The system of claim 10, wherein the executable instructions use one or more skill-pairs for encoding a skill acquisition sequence from people skill-transition data for determining the skill similarity.

18. The system of claim 10, wherein the executable instructions predict the skill demand according to the fungibility of one or more skill clusters to the target skill, historical engagements and pipeline engagements for the target skill, a factor of uncertainty for one or more pipeline engagements, or a combination thereof.

19. A computer program product for, by a processor, forecasting demand across groups of skills, the computer program product comprising a non-transitory computer-readable storage medium having computer-readable program code portions stored therein, the computer-readable program code portions comprising:
an executable portion that determines adjacency of skill similarity of one or more skills of one or more entities;
an executable portion that uses the adjacency of skill similarity to generate one or more skill clusters; and
an executable portion that forecasts skill demand of the one or more skill clusters.

20. The computer program product of claim 19, further including an executable portion that determines the adjacency of skill similarity according to semantic similarity between a description of one or more skills included in one or more data sources, people skill-transition data, or a combination thereof.

21. The computer program product of claim 19, further including an executable portion that estimates fungibility between the one or more skills, wherein fungibility is a substitution of a skill with an alternative skill with a reduced amount of time for upskilling the one or more entities with the alternative skill as compared to an amount of time training a new entity with the alternative skill.

22. The computer program product of claim 21, further including an executable portion that:
uses the fungibility to generate the one or more skill clusters; and
forecasts the skill demand at a level of the one or more skill clusters.

23. The computer program product of claim 19, further including an executable portion that:
generates one or more similarity matrices; or
combines the one or more similarity matrices into a single measure of fungibility.

24. The computer program product of claim 19, further including an executable portion that:
identifies those of the one or more skills being most fungible for a target skill;
filters the one or more entities for upskilling to the target skill according to the identified one or more skills;
identifies the one or more entities having a greater amount of fungible skills as compared to alternative entities.

25. The computer program product of claim 19, further including an executable portion that use one or more skill-pairs for encoding a skill acquisition sequence from people skill-transition data for determining the skill similarity.

26. The computer program product of claim 19, further including an executable portion that predicts the skill demand according to the fungibility of one or more skill clusters to the target skill, historical engagements and pipeline engagements for the target skill, a factor of uncertainty for one or more pipeline engagements, or a combination thereof.
